(19) United States
(12) Patent Application Publication
(10) Pub. No.: US 2015/0266245 A1
(43) Pub. Date: Sep. 24, 2015

(54) METHOD FOR MANUFACTURING FIBER-REINFORCED RESIN MATERIALS

(71) Applicant: TOYOTA JIDOSHA KABUSHIKI KAISHA, Toyota-shi (JP)

(72) Inventor: Takashi IKE, Miyoshi-shi (JP)

(73) Assignee: TOYOTA JIDOSHA KABUSHIKI KAISHA, Toyota-shi (JP)

(21) Appl. No.: 14/616,137

(22) Filed: Feb. 6, 2015

(30) Foreign Application Priority Data
Mar. 19, 2014 (JP) 2014-056812

(51) Int. Cl. B29C 70/02

(52) U.S. Cl. CPC B29C 70/021; B29K 2101/10

(57) ABSTRACT

Provided is a method for manufacturing fiber-reinforced resin materials capable of increasing the stiffness and the strength such as shock resistance by a simple method while suppressing an increase in the product weight. A continuous fiber member 5 including a plurality of continuous fibers is placed at at least a part of a fiber-reinforced resin member 3 including fiber materials 2 mixed into matrix resin 1, followed by pressing, thus impregnating gaps between the continuous fibers making up the continuous fiber member 5 with the matrix resin 1 of the fiber-reinforced resin member 3 liquefied or softened for integration.

### BACKGROUND

1. Technical Field

The present invention relates to a method for manufacturing fiber-reinforced resin materials.

2. Background Art

Fiber-reinforced resin materials (fiber-reinforced plastics (FRPs)) that include fiber materials for reinforcement mixed into resin are lightweight and have high strength, and so such materials are used in various industrial fields such as automobile, construction and aviation industry.

For instance, hybrid vehicles and electric vehicles attract the attention in the automobile industry because they are environmentally-friendly vehicles, and so automobile manufactures and automobile-related manufactures are advancing the developments to achieve smaller and lighter vehicles with higher-performance. Not only for these so-called eco-friendly cars but also for general vehicles including other general gasoline-powered and diesel-powered vehicles, there are growing needs to use the fiber-reinforced resin materials as a part or the entire of the outer panels for vehicles because they are materials satisfying both of the lightweight and higher stiffness of the vehicles.

In the case of an outer panel made of a fiber-reinforced resin material, especially a fiber-reinforced resin material including short fibers of 1 mm or shorter that are oriented at random in matrix resin, however, an end part of each fiber material making up such a fiber-reinforced resin material may be the origin of fracture, and so such an outer panel is generally known to have reduced stiffness or strength such as shock resistance.

In recent years, fiber-reinforced resin materials that are molded by sheet molding compound (SMC) techniques, having good mass productivity and a design effect, have been used for outer panels of vehicles, for example. Such fiber-reinforced resin materials molded by SMC, however, include a thermosetting resin material with typically low toughness and ductility, and so it is known that the resultant outer panel made of a fiber-reinforced resin material molded by SMC has further reduced stiffness and strength such as shock resistance.

Then, when such a conventional fiber-reinforced resin material is used for a hood inner of a hood panel, for example, a part surrounding a striker of the hood inner may be damaged when the vehicle collides at a front part thereof, for example.

Then, when a fiber-reinforced resin material is used for an outer panel of a vehicle, such as a hood panel, a reinforcement made of a steel plate or an aluminum plate may be bonded to the rear face of the panel via an adhesive or a fastening member, or a ribbed-structure may be used there to provide ribs on the surface of the panel so as to suppress damage from the external impact at the time of collision of vehicle, for example (see Patent Document 1, for example).

### RELATED ART DOCUMENT

### Patent Document

Patent Document 1: WO 2012/101793

### SUMMARY

Such a conventional countermeasure, however, causes a problem of an increase in the product weight due to a reinforcement, an adhesive or a fastening member to bond the reinforcement, ribs provided on the surface of the panel and the like. When a continuous fiber-reinforced resin member including continuous fibers mixed into matrix resin is stacked as a reinforcement material on a resin member as a substrate as disclosed in Patent document 1, another problem occurs, requiring an adhesion layer between the substrate and the reinforcement material, the adhesion layer being made of a thermoplastic resin that allows the substrate and the reinforcement material to adhere favorably due to its melting and softening.

In view of the aforementioned problems, the present invention aims to provide a method for manufacturing fiber-reinforced resin materials capable of increasing the stiffness and the strength such as shock resistance by a simple method while suppressing an increase in the product weight.

To achieve the aim, a method for manufacturing a fiber-reinforced resin material according to one embodiment of the present invention includes: placing a continuous fiber member including a plurality of continuous fibers at at least a part of a fiber-reinforced resin member including fiber materials mixed into matrix resin, followed by pressing, thus impregnating gaps between the continuous fibers with the matrix resin liquefied or softened for integration.

According to this manufacturing method, a continuous fiber member is placed at at least a part of a fiber-reinforced resin member, followed by pressing, thus impregnating gaps between the continuous fibers making up the continuous fiber member with the matrix resin making up the fiber-reinforced resin member for integration, whereby stiffness and strength such as shock resistance can be increased by a simple method while suppressing an increase in the product weight.

The matrix resin for the fiber reinforcement resin may be thermosetting resin or thermoplastic resin. Note here that when the matrix resin includes thermosetting resin, such resin has typically low toughness and ductility (becoming brittle) as compared with thermoplastic resin, and is easily damaged by an external impact. In such a case as well, the above manufacturing method can effectively increase stiffness and strength such as shock resistance.

The fiber materials included in the fiber reinforcement resin may be either so-called short fiber materials (e.g., 1 mm or less) or long fiber materials (e.g., 50 mm or less), or may be the mixture of short fiber materials and long fiber materials. The continuous fiber member including continuous fibers may a unidirectional material in which fiber materials longer than the long fiber material (e.g., fiber materials having length longer than 50 mm) are unidirectionally oriented, or quasi-isotropic materials (e.g., non-woven cloth, fabric members including warp threads and weft threads, and a lamination of them).

In another embodiment of the method for manufacturing a fiber-reinforced resin material as stated above, a plurality of the continuous fiber members are prepared, and the plurality of continuous fiber members are placed at at least a part of the fiber-reinforced resin member while having gaps between the plurality of continuous fiber members.

According to such a manufacturing method, a plurality of the continuous fiber members are placed at at least a part of the fiber-reinforced resin member, followed by pressing, thus impregnating gaps between the continuous fiber members placed on the fiber-reinforced resin member with the matrix resin making up the fiber-reinforced resin member for integration, whereby stiffness and strength such as shock resistance can be increased more effectively by a simple method.

In another embodiment of the method for manufacturing a fiber-reinforced resin material as stated above, a plurality of the fiber-reinforced resin members are prepared, and the plurality of fiber-reinforced resin members with the continuous fiber members intervening therebetween are pressed.

In still another embodiment of the method for manufacturing a fiber-reinforced resin material as stated above, another fiber-reinforced resin member with fiber content lower than the fiber-reinforced resin member is prepared, and the fiber-reinforced resin member and the other fiber-reinforced resin member with the continuous fiber members intervening therebetween are pressed.

In a further embodiment of the method for manufacturing a fiber-reinforced resin material as stated above, a resin member made of a resin of a same type as the matrix resin is prepared, and the fiber-reinforced resin member and the resin member with the continuous fiber members intervening therebetween are pressed.

In any method of the embodiments as stated above, gaps between the continuous fibers of the continuous fiber members or gaps between the continuous fiber members intervening between the plurality of the fiber-reinforced resin members or between the fiber-reinforced resin member and the resin member are impregnated with the matrix resin making up the fiber-reinforced resin member or the like for integration, whereby stiffness and strength such as shock resistance can be effectively increased while suppressing an increase in the product weight.

As can be understood from the above description, the present invention is for manufacturing a fiber-reinforced resin material including a fiber-reinforced resin member as a substrate, and is to place a continuous fiber member including a plurality of continuous fibers at at least a part of a fiber-reinforced resin member including fiber materials mixed into matrix resin, followed by pressing, thus impregnating gaps between the continuous fibers making up the continuous fiber member with the matrix resin liquefied or softened for integration, and such a simple method can increase stiffness and strength such as shock resistance while suppressing an increase in the product weight.

### BRIEF DESCRIPTION OF THE DRAWINGS

FIGS. 1A and 1B schematically describe a method for manufacturing fiber-reinforced resin materials that is Embodiment 1 of the present invention, where FIG. 1A describes a placing step, and FIG. 1B describes a pressing step.

FIGS. 2A and 2B schematically describe a modification of the method for manufacturing fiber-reinforced resin materials that is Embodiment 1 of the present invention in FIG. 1, where FIG. 2A describes a placing step, and FIG. 2B describes a pressing step.

FIGS. 3A and 3B schematically describes a method for manufacturing fiber-reinforced resin materials that is Embodiment 2 of the present invention, where FIG. 3A describes a placing step, and FIG. 3B describes a pressing step.

FIGS. 4A and 4B schematically describes a method for manufacturing fiber-reinforced resin materials that is Embodiment 3 of the present invention, where FIG. 4A describes a placing step, and FIG. 4B describes a pressing step.

FIG. 5 is an exploded perspective view schematically illustrating a hood panel including a hood inner made of a fiber-reinforced resin material that is manufactured by the example.

FIG. 6 schematically describes the manufacturing steps for the hood inner of FIG. 5.

### DETAILED DESCRIPTION OF THE EMBODIMENT(S)

The following describes embodiments of a method for manufacturing fiber-reinforced resin materials of the present invention, with reference to the drawings. The following describes embodiments, in which a method for manufacturing fiber-reinforced resin materials of the present invention is used to manufacture a hood inner of a hood panel to be disposed at a front part of a vehicle, and the method for manufacturing fiber-reinforced resin materials of the present invention can be used to manufacture panels for vehicles other than a hood inner of a hood panel or panels used for appropriate applications other than vehicles, for example.

### Embodiment 1

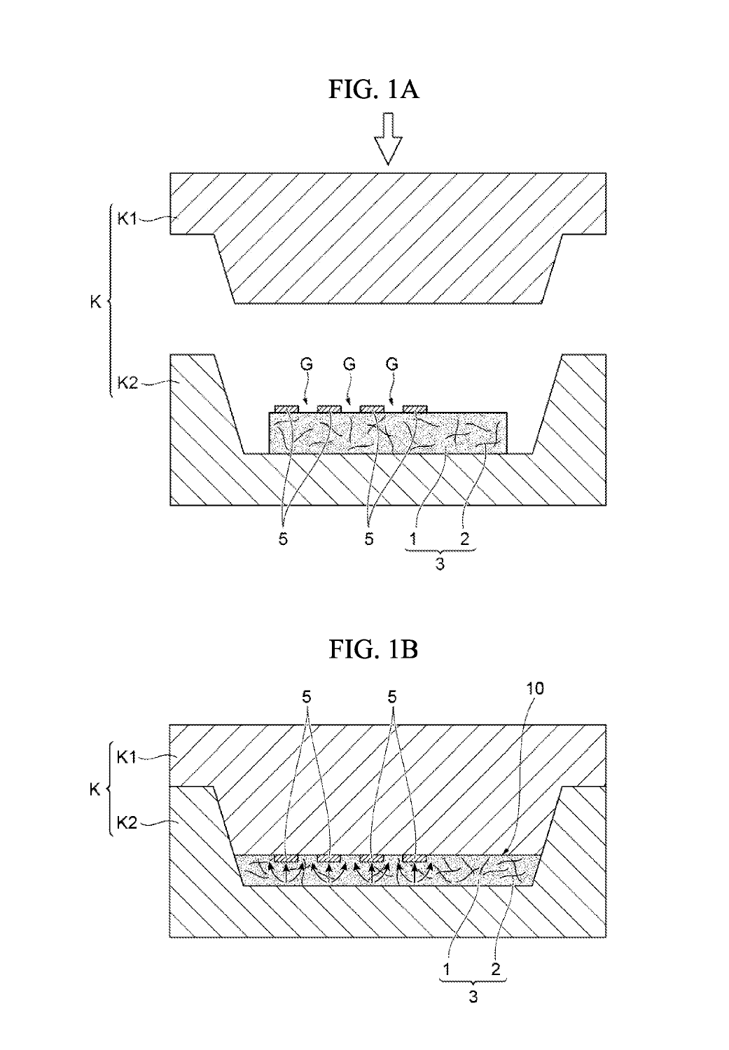

FIG. 1 schematically describes a method for manufacturing fiber-reinforced resin materials that is Embodiment 1 of the present invention. As illustrated in the drawing, the manufacturing method of Embodiment 1 mainly includes a placing step and a pressing step.

In the manufacturing method of Embodiment 1, a fiber-reinforced resin member 3 as a sheet-form substrate, including fiber materials 2 mixed in matrix resin 1, and a continuous fiber member 5 as a sheet-form substrate, including a plurality of continuous fibers, are prepared beforehand. Then as illustrated in FIG. 1A, the fiber-reinforced resin member 3 is placed on a lower mold K2 of a mold K, and the continuous fiber member 5 is placed on an upper face of the fiber-reinforced resin member 3 (placing step). Preferably a plurality of continuous fiber members 5 are prepared as illustrated in the drawing, and such a plurality of continuous fiber members 5 are placed on the upper face of the fiber-reinforced resin member 3 so as to have gaps G therebetween. Continuous fibers of these continuous fiber members 5 may be of the same type or of different types.

Herein the fiber-reinforced resin making up the fiber-reinforced resin member 3 is the matrix resin 1 with fiber materials 2 for reinforcement mixed therein, and this matrix resin 1 may be thermosetting resin or thermoplastic resin. Examples of the thermosetting resin include epoxy resin, phenol resin and melamine resin, and examples of the thermoplastic resin include any one type or two types or more of the mixture material of polypropylene (PP), polyethylene (PE), polystyrene (PS), AS resin, ABS resin, polyvinyl chloride (PVC), metacrylate resin, polyamide (PA), polyester, polyacetal (POM), polycarbonate (PC), polyethylene terephthalate (PET), polybutylene terephthalate (PBT), polymethylmethacrylate (PMMA), polyvinylidene fluoride, polyphenylene oxide, polyphenylene sulfide, polyether ether ketone, liquid crystal polymer, polyetherimide, polyethersulfone, polyamide imide and thermoplastic epoxy resin. Copolymer, graft resin or blend resin containing such thermoplastic resin as a main component, such as ethylene-vinyl chloride copolymer, vinyl acetate-ethylene copolymer, vinyl acetate-vinyl chloride copolymer, urethane-vinyl chloride copolymer, acrylic-acid modified polypropylene or maleic-acid modifier polyethylene may be introduced therein.

The fiber material 2 contained in the fiber-reinforced resin may be either so-called short fiber materials (e.g., 1 mm or less) or long fiber materials (e.g., 50 mm or less), or may be the mixture of short fiber materials and long fiber materials. Examples of the fiber material 2 include any one type or the mixture of two or more types of ceramic fibers such as boron, alumina, silicon carbide, silicon nitride, and zirconia, inorganic fibers such as glass fibers and carbon fibers, metal fibers such as copper, steel, aluminum and stainless steel, and organic fibers such as polyamide, polyester, cellulose, polypropylene and polyethylene.

The continuous fiber member 5 including continuous fibers may a unidirectional material in which fiber materials longer than the fiber material 2 (e.g., fiber materials having length longer than 50 mm) making up the fiber-reinforced resin member 3 are unidirectionally oriented, or quasi-isotropic materials (e.g., 0° directional materials, 90° directional materials, ±45° directional materials, multiaxial laminated materials in which a plurality of directional materials, such as 0°, 90°, and ±45° directional materials are laminated, non-woven cloth, fabric members including warp threads and weft threads).

Next, as illustrated in FIG. 1B, a upper mold K1 of the mold K is brought closer to the lower mold K2 for closing, thus pressing the fiber-reinforced resin member 3 and the continuous fiber members 5 vertically (pressing step). Then, the fiber-reinforced resin member 3 is cured to integrate the fiber-reinforced resin member 3 and the continuous fiber members 5 to form a fiber-reinforced resin material 10, and then the fiber-reinforced resin material 10 is removed from the mold K.

In this way, according to the manufacturing method of Embodiment 1, the continuous fiber member 5 as a reinforcement material is placed on the upper face of the fiber-reinforced resin member 3, followed by pressing, whereby the gaps (weave patterns between the fiber materials, for example) between the continuous fibers making up the continuous fiber member 5 are impregnated with the matrix resin 1 in the softening state making up the fiber-reinforced resin member 3 during the pressing step so that the fiber-reinforced resin member 3 and the continuous fiber member 5 are integrated. In this way, stiffness and strength such as shock resistance can be increased by a simple method while suppressing an increase in the product weight.

Since a plurality of the continuous fiber members 5 are placed on the upper face of the fiber-reinforced resin member 3 with gaps G therebetween, followed by pressing, whereby the gaps G between the continuous fiber members 5 can be impregnated with the matrix resin 1 in the softening state making up the fiber-reinforced resin member 3 during the pressing step so that the fiber-reinforced resin member 3 and the plurality of continuous fiber members 5 are integrated. In this way, stiffness and strength such as shock resistance can be increased more effectively by a simple method.

When the matrix resin 1 making up the fiber-reinforced resin member 3 is made of thermoplastic resin, the matrix resin 1 may be molten during the pressing step shown in FIG. 1B, with which the gaps between the continuous fibers making up the continuous fiber member 5 or the gaps G between the continuous fiber members 5 may be impregnated.

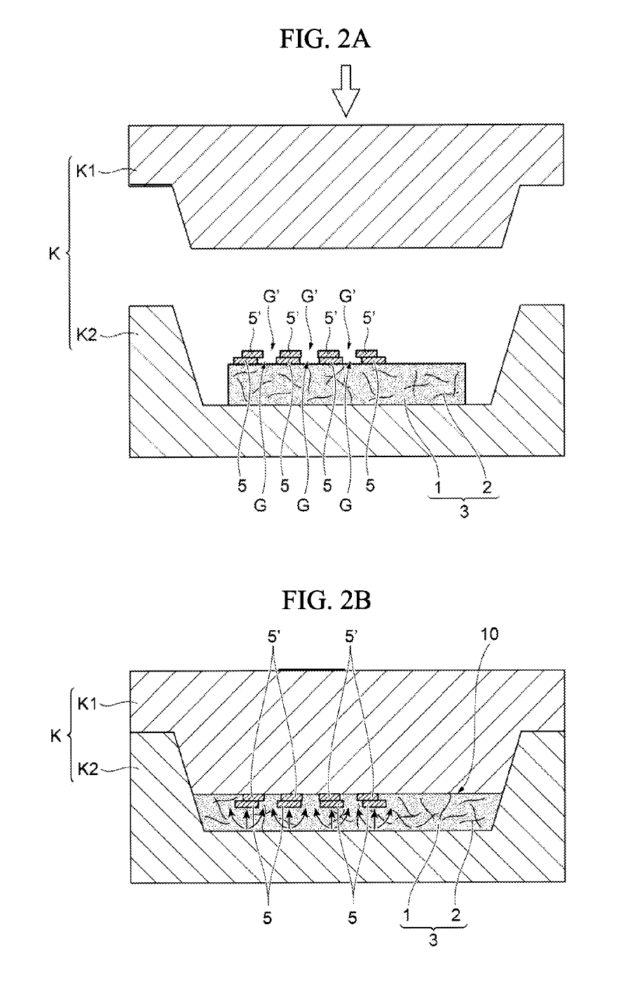

For more increased strength of the fiber-reinforced resin material 10, as illustrated in FIG. 2, a plurality of continuous fiber members 5′ made of continuous fibers of the same type or a different type of the continuous fibers making up the continuous fiber member 5 may be prepared. Then, after the plurality of continuous fiber members 5 are placed on the upper face of the fiber-reinforced resin member 3 disposed on the lower mold K2 of the mold K, such a plurality of continuous fiber members 5′ may be successively placed on the plurality of continuous fiber members 5 for lamination, followed by pressing for integration of the fiber-reinforced resin member 3 with the plurality of continuous fiber members 5, 5′. As the number of the lamination of the continuous fiber members 5, 5′ increases, the degree of impregnation of the continuous fiber members 5, 5′ with the matrix resin 1 in the fiber-reinforced resin member 3 may deteriorate. In that case, the fiber content of the fiber-reinforced resin member 3 may be decreased and the resin content of the fiber-reinforced resin member 3 may be increased so as to increase the degree of impregnation of the continuous fiber members 5, 5′ with the matrix resin 1.

### Embodiment 2

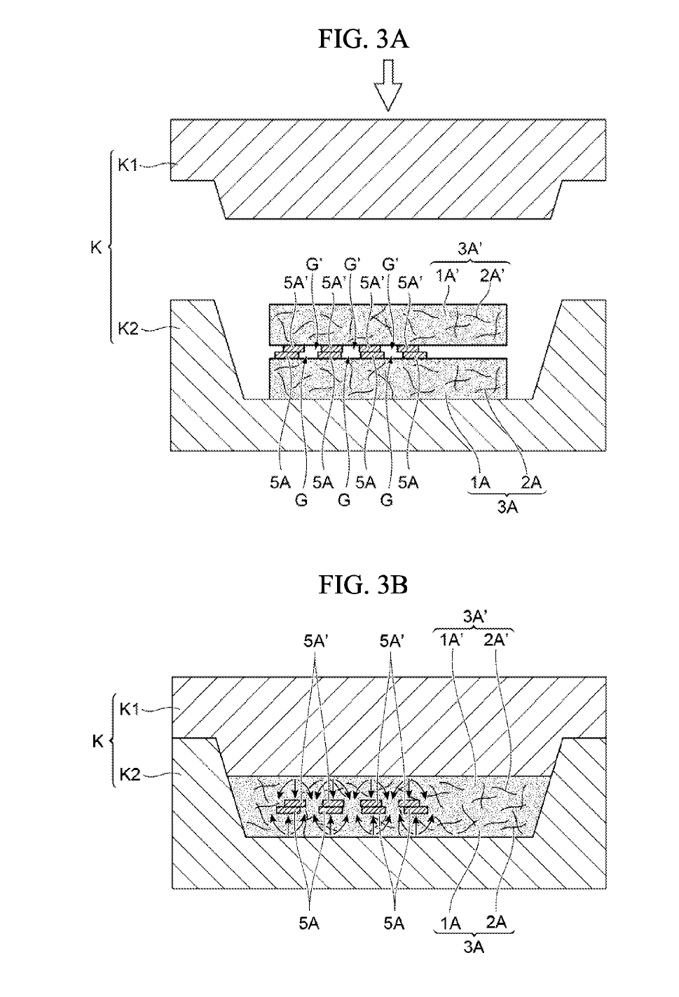

FIG. 3 schematically describes a method for manufacturing fiber-reinforced resin materials that is Embodiment 2 of the present invention. The manufacturing method of Embodiment 2 illustrated in FIG. 3 is different from the manufacturing method of Embodiment 1 illustrated in FIGS. 1 and 2 in the number of the fiber-reinforced resin members used, and the other configuration is similar to the manufacturing method of Embodiment 1. Therefore like reference numerals designate like parts of Embodiment 1, and their descriptions are omitted.

As described above, as the number of the lamination of the continuous fiber members to be placed on the upper face of the fiber-reinforced resin member increases, the degree of impregnation of the continuous fiber members with the matrix resin in the fiber-reinforced resin member may deteriorate. To cope with this, in the manufacturing method of Embodiment 2, a plurality of fiber-reinforced resin member 3A, 3A′ in which fiber material 2A, 2A′ is mixed in matrix resin 1A, 1A′, and a plurality of continuous fiber member 5A, 5A′ including a plurality of continuous fibers are prepared beforehand. Then as illustrated in FIG. 3A, the fiber-reinforced resin member 3A is placed on the lower mold K2 of the mold K, on the upper face of the fiber-reinforced resin member 3A, a plurality of continuous fiber members 5A, 5A′ are successively placed for lamination, and on the plurality of continuous fiber members 5A′, the fiber-reinforced resin member 3A′ is disposed (placing step).

Next, as illustrated in FIG. 3B, the upper mold K1 of the mold K is brought closer to the lower mold K2 for closing, thus pressing the fiber-reinforced resin member 3A, the plurality of continuous fiber members 5A, 5A′ and the fiber-reinforced resin member 3A′ vertically (pressing step). When the continuous fiber members 5A, 5A′ intervene between the fiber-reinforced resin members 3A, 3A′, these fiber-reinforced resin members 3A, 3A′ are brought into intimate contact with each other via the continuous fiber members 5A, 5A′ during this pressing step. When the continuous fiber members 5A, 5A′ do not intervene between the fiber-reinforced resin members 3A, 3A′, the fiber-reinforced resin members 3A, 3A′ are brought into intimate contact with each other directly during this pressing step.

In this way, according to the manufacturing method of Embodiment 2, the plurality of fiber-reinforced resin members 3A, 3A′ with the continuous fiber members 5A, 5A′ intervening therebetween are pressed, whereby the gaps (weave patterns between the fiber materials, for example) between the continuous fibers making up the continuous fiber members 5A, 5A′, the gaps G between the continuous fiber members 5A, and the gaps G′ between the continuous fiber member 5A′ are impregnated with the matrix resin 1A, 1A′ in the liquefied, softening, or molten state of the fiber-reinforced resin members 3A, 3A′ disposed above and below the continuous fiber members 5A, 5A′ during the pressing step so that the fiber-reinforced resin members 3A, 3A′ and the continuous fiber members 5A, 5A′ are integrated. That is, the degree of impregnation of the continuous fiber members 5A, 5A′ with the matrix resin 1A, 1A′ in the fiber-reinforced resin members 3A, 3A′ can be increased, and so stiffness and strength such as shock resistance can be increased effectively by a simple method.

The fiber content of at least one of the plurality of fiber-reinforced resin members 3A, 3A′ may be decreased and the resin content of the fiber-reinforced resin member may be increased, whereby the degree of impregnation of the continuous fiber members 5A, 5A′ with the matrix resin 1A, 1A′ can be increased, and so stiffness and strength such as shock resistance can be increased more effectively.

### Embodiment 3

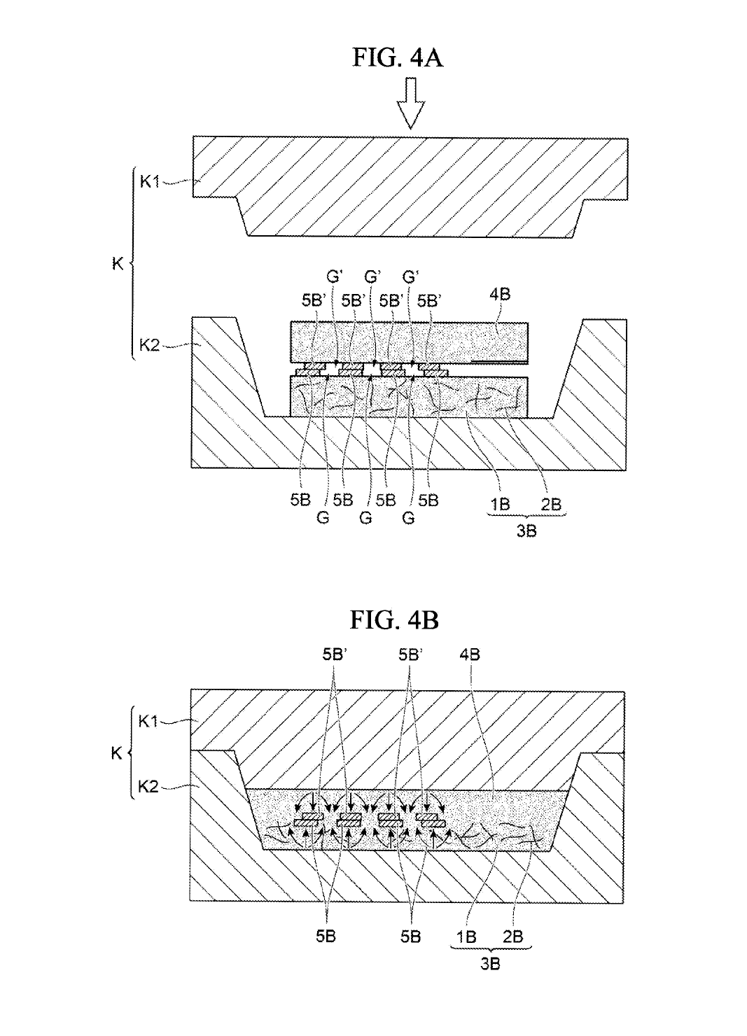

FIG. 4 schematically describes a method for manufacturing fiber-reinforced resin materials that is Embodiment 3 of the present invention. The manufacturing method of Embodiment 3 illustrated in FIG. 4 is different from the manufacturing method of Embodiment 2 illustrated in FIG. 3 in the types of members to be displaced in the mold, and the other configuration is similar to the manufacturing method of Embodiment 2. Therefore like reference numerals designate like parts of Embodiment 2, and their descriptions are omitted.

As described above, decreasing the fiber content of the fiber-reinforced resin members to be disposed above and below the continuous fiber members means increasing in the degree of impregnation of the continuous fiber members with the matrix resin. Then, in the manufacturing method of Embodiment 3, a fiber-reinforced resin member 3B including fiber materials 2B mixed into matrix resin 1B and a plurality of continuous fiber members 5B, 5B′ including a plurality of continuous fibers are prepared beforehand, and a resin member (e.g., film-form resin film) 4B made of the same type of resin as that of the matrix resin 1B making up the fiber-reinforced resin member 3B is prepared. Then, as illustrated in FIG. 4A, the fiber-reinforced resin member 3B is placed on the lower mold K2 of the mold K, and on the upper face of the fiber-reinforced resin member 3B, the plurality of continuous fiber member 5B, 5B′ are successively placed for lamination. Then, on the plurality of continuous fiber member 5B′, the resin member 4B is placed (placing step).

Next, as illustrated in FIG. 4B, the upper mold K1 of the mold K is brought closer to the lower mold K2 for closing, thus pressing the fiber-reinforced resin member 3B, the plurality of continuous fiber members 5B, 5B′ and the rein member 4B vertically (pressing step). When the continuous fiber members 5B, 5B′ intervene between the fiber-reinforced resin member 3B and the resin member 4B, these fiber-reinforced resin member 3B and the resin member 4B are brought into intimate contact with each other via the continuous fiber members 5B, 5B′ during this pressing step. When the continuous fiber members 5B, 5B′ do not intervene between the fiber-reinforced resin member 3B and the resin member 4B, the fiber-reinforced resin member 3B and the resin member 4B are brought into intimate contact with each other directly during this pressing step.

In this way, according to the manufacturing method of Embodiment 3, the fiber-reinforced resin member 3B and the resin member 4B with the continuous fiber members 5B, 5B′ intervening therebetween are pressed, whereby the gaps (weave patterns between the fiber materials, for example) between the continuous fibers making up the continuous fiber members 5B, 5B′, the gaps G between the continuous fiber members 5B and the gaps G′ between the continuous fiber members 5B′ are impregnated with the matrix resin in the fiber-reinforced resin member 3B in the liquefied, softening, or molten state and the rein in resin member 4B in the softening or molten state disposed above and below the continuous fiber member 5B, 5B′ during the pressing step so that the fiber-reinforced resin member 3B, the continuous fiber members 5B, 5B′ and the resin member 4B are integrated. This means that the degree of impregnation of the continuous fiber members 5B, 5B′ with the matrix resin of the fiber-reinforced resin member 3B and the resin of the resin member 4B can be more increased, and so stiffness and strength such as shock resistance can be further increased.

The resin making up the resin member 4B may be any resin as long as it has physical properties such as a linear expansion coefficient and Young's modulus equal to those of the matrix resin 1B making up the fiber-reinforced resin member 3B, for example, and it can achieve the adhesiveness with the fiber-reinforced resin member 3B.

### EXAMPLE

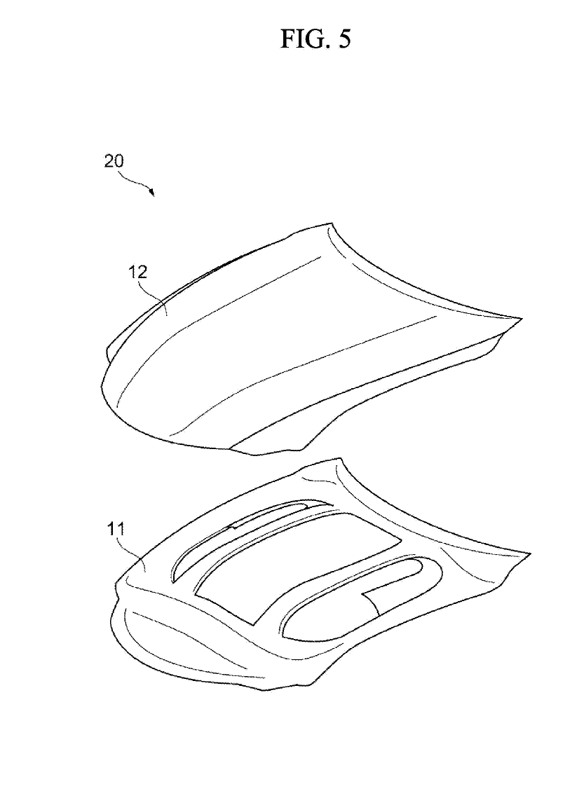

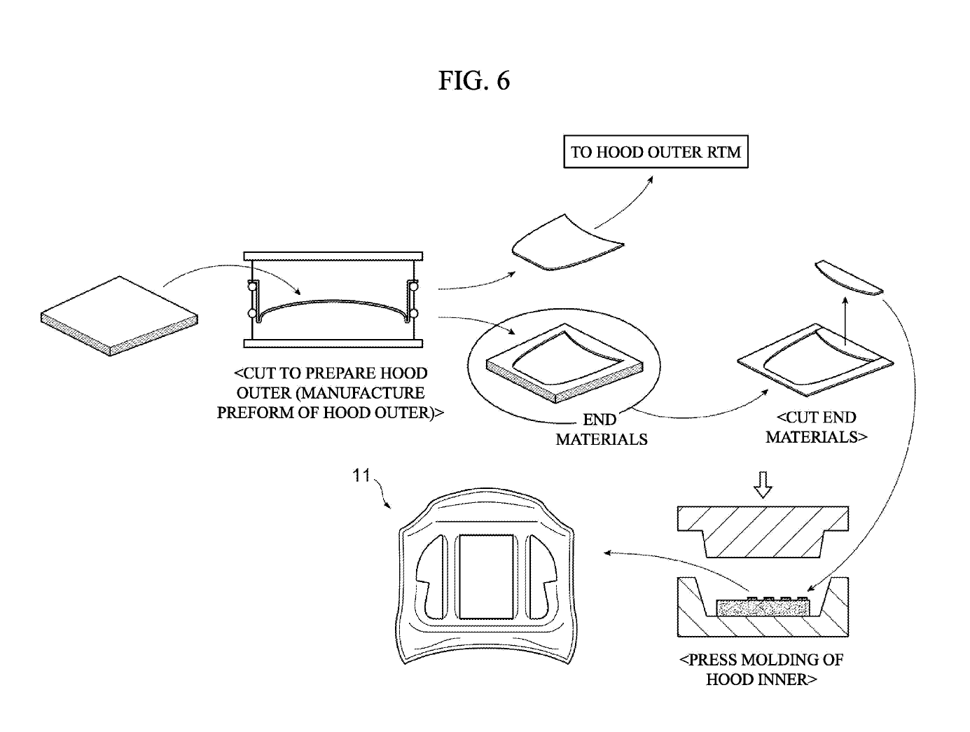

The following roughly describes a method (example) for manufacturing a hood inner of a hood panel that is used in a vehicle by a method complying with the manufacturing method of Embodiment 1 as stated above. FIG. 5 is an exploded perspective view schematically illustrating a hood panel including a hood inner made of a fiber-reinforced resin material that is manufactured by the example. FIG. 6 schematically describes the manufacturing steps for the hood inner of FIG. 5.

As illustrated in FIG. 5, a hood panel 20 roughly includes a hood outer 12 defining the outer surface, and a hood inner 11 to be bonded to an inner surface side of the hood outer 12 with an adhesive or the like to support the hood outer 12. The hood inner 11 is manufactured mainly using an end material that is discharged when a continuous fiber substrate (typically carbon fiber fabric as a quasi-isotropic material) made of a plurality of carbon fibers is cut to manufacture the hood outer 12, and a fiber-reinforced resin member by SMC molding in which short fiber materials made of carbon fibers of 1 mm or less are oriented at random in thermosetting resin.

Such a hood inner 11 is roughly manufactured as follows. As illustrated in FIG. 6, the end material that is discharged when cutting a continuous fiber substrate to manufacture the hood outer 12 is collected, and a part of the end material is cut into a predetermined shape. Then, such a plurality of end materials after cutting are placed at appropriate places on a fiber-reinforced resin member (of a few millimeters in thickness) by SMC molding, which is disposed in a mold, to have gaps therebetween. Then, the mold is closed for pressing of the fiber-reinforced resin member and the end materials (continuous fiber substrate) to cure the thermosetting resin of the fiber-reinforced resin member. In this way, the fiber-reinforced resin member and the end materials are integrated to mold the hood inner 11, and the hood inner 11 is removed from the mold.

The hood outer 12 is prepared as follows. That is, the aforementioned continuous fiber substrate made of carbon fibers is cut, stacked and shaped to prepare a preform (a compact before impregnation with resin), and the preform is placed into a mold, and the mold is closed. Then resin (matrix resin) is poured into the mold for impregnation into the preform, followed by curing and then removing from the mold. In this way, the hood outer can be molded (RTM: Resin Transfer Molding).

As described in details based on Embodiment 1 in the above, during press molding of the fiber-reinforced resin member and the end materials in the manufacturing process of this hood inner 11, the gaps (weave patterns between the fiber materials) between the carbon fibers making up the end materials (continuous fiber substrate) and the gaps between the end materials are impregnated with the thermosetting resin (matrix resin) making up the fiber-reinforced resin member, whereby the fiber-reinforced resin member and the end materials are integrated. Since the fiber-reinforced resin member are reinforced reliably by the end materials (continuous fiber substrate), and so stiffness and strength at desired positions of the hood inner 11 can be increased effectively while suppressing an increase in the product weight.

That is a detailed description of the embodiments of the present invention. However, the present invention is not limited to the above-stated embodiments, and the design may be modified variously without departing from the spirits of the present invention defined in the attached claims.

### DESCRIPTION OF SYMBOLS

1 Matrix resin
2 Fiber material
3 Fiber-reinforced resin member
5 Continuous fiber member
10 Fiber-reinforced resin material
11 Inner panel
12 Outer panel
20 Hood panel

### K Mold

K1 Upper mold
K2 Lower mold

What is claimed is:

1. A method for manufacturing a fiber-reinforced resin material, comprising:
placing a continuous fiber member including a plurality of continuous fibers at at least a part of a fiber-reinforced resin member including fiber materials mixed into matrix resin, followed by pressing, thus impregnating gaps between the continuous fibers with the matrix resin liquefied or softened for integration.

2. The method for manufacturing a fiber-reinforced resin material according to claim 1, wherein the matrix resin comprises thermosetting resin.

3. The method for manufacturing a fiber-reinforced resin material according to claim 1 or 2, wherein
a plurality of the continuous fiber members are prepared, and the plurality of continuous fiber members are placed at at least a part of the fiber-reinforced resin member while having gaps between the plurality of continuous fiber members.

4. The method for manufacturing a fiber-reinforced resin material according to claim 1, wherein
a plurality of the fiber-reinforced resin members are prepared, and the plurality of fiber-reinforced resin members with the continuous fiber members intervening therebetween are pressed.

5. The method for manufacturing a fiber-reinforced resin material according to claim 1, wherein
another fiber-reinforced resin member with fiber content lower than the fiber-reinforced resin member is prepared, and the fiber-reinforced resin member and the other fiber-reinforced resin member with the continuous fiber members intervening therebetween are pressed.

6. The method for manufacturing a fiber-reinforced resin material according to claim 1, wherein
a resin member made of a resin of a same type as the matrix resin is prepared, and the fiber-reinforced resin member and the resin member with the continuous fiber members intervening therebetween are pressed.
